(19) United States
(12) Patent Application Publication
(10) Pub. No.: US 2007/0035920 A1
(43) Pub. Date: Feb. 15, 2007

(54) MOUNTING APPARATUS FOR DATA STORAGE DEVICES

(75) Inventors: WEN-TANG PENG, Tu-Cheng,Taipei Hsien (TW); Guang-Yi Zhang, Shenzhen (CN); Jiang-Ping Zhu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,954

(22) Filed: May 29, 2006

(30) Foreign Application Priority Data
Aug. 12, 2005 (CN) 200520063114.7

(51) Int. Cl. G06F 1/16

(52) U.S. Cl. 361/685

(57) ABSTRACT

A mounting apparatus for mounting a data storage device that defines a pair of locking holes in each of two opposite sidewalls thereof includes a pair of rails, a bracket, and a connecting member. Each of the rails is adapted for attaching to a corresponding sidewall of the data storage device. Each of the rails includes a pair of posts extending therefrom for engaging with the corresponding locking holes of the data storage device. The bracket for holding the data storage device includes a pair of side walls each defining a track for holding a corresponding rail to slide therein. The connecting member connects the rails to each other.

### FIELD OF THE INVENTION

The present invention relates to mounting apparatuses, and particularly to a mounting apparatus which readily allows securely installing or removing a data storage device to or from a computer enclosure.

### DESCRIPTION OF RELATED ART

Generally speaking, when a computer is assembled, a drive bracket is mounted in a computer enclosure, and then data storage devices are fixed to the drive bracket. The data storage devices comprise various combinations of hard disk drives (HDDs), floppy disk drives (FDDs), and compact disk-read only memory (CD-ROM) drives.

Conventionally, a data storage device is attached to a drive bracket of a computer by bolts. The data storage device may, for example, be a hard disk drive, a floppy disk drive, or a CD-ROM drive. However, attachment by bolts is complicated and time-consuming. Furthermore, attachment by such means requires extra work space be available inside the computer enclosure. This requirement runs counter to the trend toward miniaturization in the computer industry.

To overcome the above problems, rails have been developed to mount a data storage device to a computer enclosure. Such rails are disclosed in Taiwan Patent Application No. 82202204 and a U.S. Pat. No. 5,332,306. Two such rails are attached to respective opposite sides of a data storage device. This assembly is then slidably inserted into the computer enclosure. However, the rails may easily fall off when installing or uninstalling the data storage device.

What is desired, therefore, is a mounting apparatus which readily allows securely installing or removing a data storage device to or from a computer enclosure.

### SUMMARY OF THE INVENTION

An exemplary mounting apparatus for mounting a data storage device that defines a pair of locking holes in each of two opposite sidewalls thereof includes a pair of rails, a bracket, and a connecting member. Each of the rails is adapted for attaching to a corresponding sidewall of the data storage device. Each of the rails includes a pair of posts extending therefrom for engaging with the corresponding locking holes of the data storage device. The bracket for holding the data storage device includes a pair of side walls each defining a track for holding a corresponding rail to slide therein. The connecting member connects the rails to each other.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a mounting apparatus for a data storage device in accordance with a preferred embodiment of the present invention, together with a data storage device, the mounting apparatus includes a bracket, a pair of rails, and a connecting member;

FIG. 2 is an assembled view of the rails and the connecting member of FIG. 1, but viewed from another aspect;

FIG. 3 is similar to FIG. 2, but viewed from another aspect;

FIG. 4 is an assembled, top plan view of the data storage device, the rails, and the connecting member of FIG. 1, showing the rails unlocked;

FIG. 5 is an assembled view of the data storage device, the rails, and the connecting member of FIG. 1, but viewed from another aspect; and

FIG. 6 is an assembled view of FIG. 1.

### DETAILED DESCRIPTION OF THE INVENTION

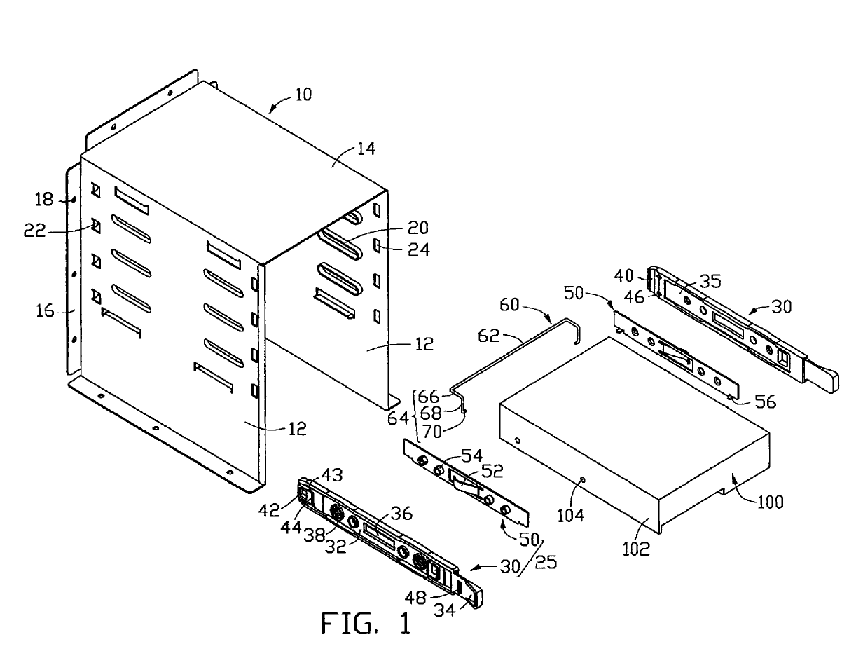

Referring to FIG. 1, a mounting apparatus of an electronic device like a computer in accordance with a preferred embodiment of the present invention is shown for mounting a functional component like a data storage device 100 to an enclosure of the computer. The data storage device 100 defines a pair of locking holes 104 in opposite sidewalls 102 thereof. The mounting apparatus includes a bracket 10, and a rail assembly. The rail assembly includes a pair of rails 25, and a resilient connecting member 60 connecting the rails 25 together.

The bracket 10 includes a top wall 14, and a pair of side walls 12 extending down from opposite sides of the top wall 14. Flanges 16 defining a plurality of mounting holes 18 are bent perpendicularly from the top wall 14 and the side walls 12 for fixing the bracket 10 to the computer enclosure. Each side wall 12 has a plurality of tracks between every two rows of supporting members 20 that protrudes in pairs therefrom. Each track may accommodate a corresponding rail 25 to slide therein. A blocking tab 22 is stamped inwardly from the rear side of each side wall 12 between every two supporting members 20. A coupling mechanism, such as a fixing hole 24 is defined in a front side of each side wall 12 between every two supporting members 20.

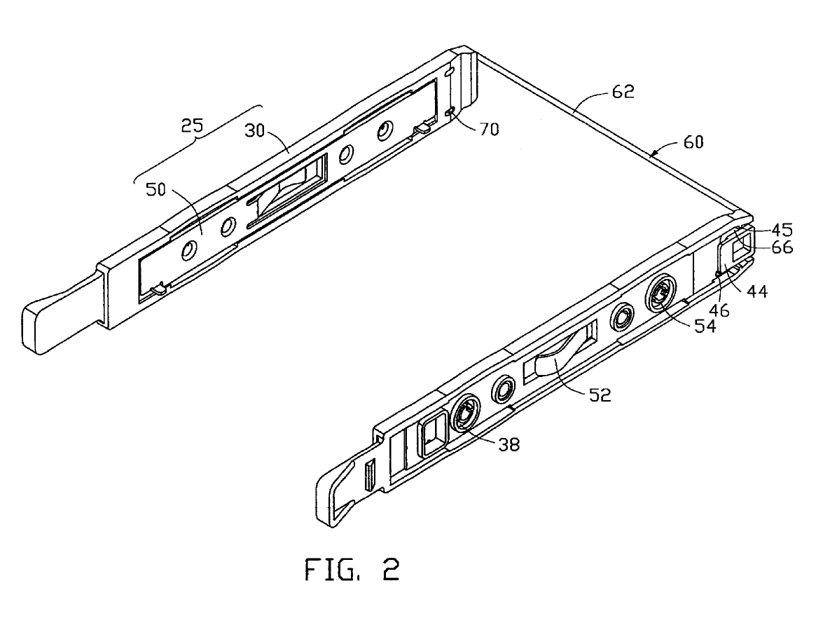

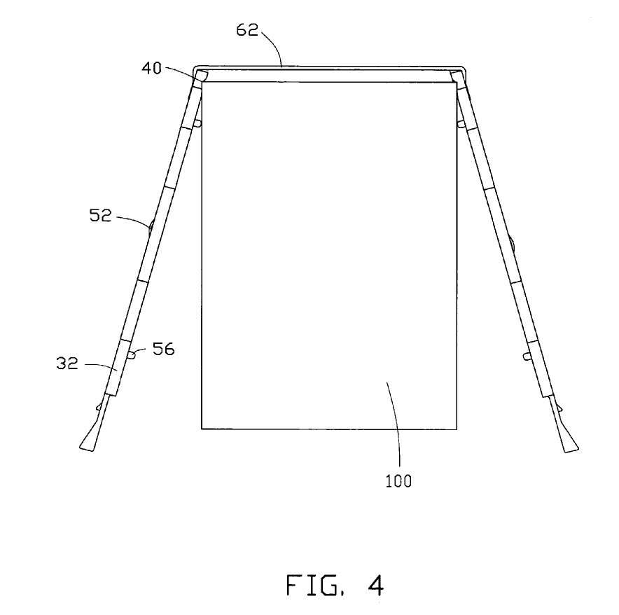

Each rail 25 includes a body 30 defining an inset portion 32 therein, and a fastener 50 attached to the body 30 for fixing the body 30 to the data storage device 100. An operating portion 34 extends forward from the body 30. A latch mechanism, such as a protrusion 48 having a slanting surface protrudes from the operating portion 34, corresponding to the locking hole 24 of the bracket 20. A through-hole 36 is defined in the body 30. Two pairs of mounting holes 38 are defined in the body 30. Mounting holes 38 of one pair are located at a side of the through-hole 36. Mounting holes 38 of the other pair are located at an opposite side of the through-hole 36. An avoiding slot 40 is defined in an inner surface of an end opposite to the operating portion 34 of the body 30, for receiving a corresponding corner of the data storage device 100 (see FIG. 4). A projecting member 42 is extended into the inset portion 32 from the body 30 opposite to the operating portion 34. A retaining slot 43 is defined between the projecting member 42 and an upper portion of the body 30. An extension tab 44 extends toward the operating portion 34 from an outer surface of the projecting member 42. A restricting tab 45 (see FIG. 2) extends into the retaining slot 43 from the upper portion of the body 30. A hole 46 is defined in a lower portion of the body 30.

The fasteners 50 are preferably made of a conductive material for grounding the data storage device 100 to the computer enclosure. Each fastener 50 includes a pair of posts 56 extending from a bottom thereof for engaging in the corresponding locking holes 104 of the data storage device 100. An arc-shaped elastic tab 52 is stamped from the fastener 50 opposite to the posts 56. Two pairs of hollow pillars 54, each pillar defining a through-hole therein extend from each of the fasteners 50 opposite to the posts 56. A pair of pillars 54 is located at each side of each of the elastic tabs 52.

The connecting member 60 includes an elastic wire, the elastic wire includes a horizontal main part 62 having two distal ends, and a pair of mounting portions 64 each extending from a corresponding distal end of the main part 62. Each mounting portion 64 includes a connecting portion 66 perpendicularly extending forward from a corresponding distal end of the main part 62, an orientating portion 68 extending downward from a distal end of the connecting portion 66, and a securing portion 70 perpendicularly extending from a distal end of the connecting portion 68 toward the data storage device 100.

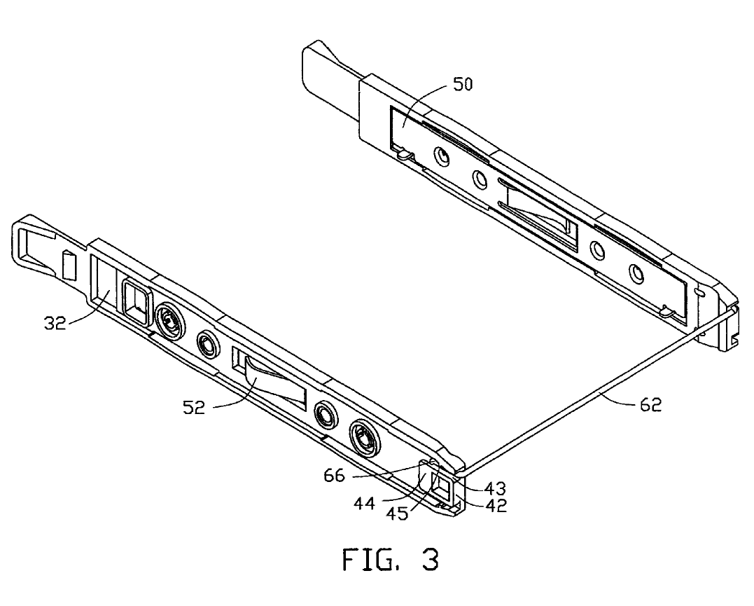

Referring also to FIGS. 2 and 3, in assembling the rail assembly, the pillars 54 of each fastener 50 are inserted into the mounting holes 38 of a corresponding body 30. The pillars 54 of each fastener 50 are hammered on a distal end thereof to secure the fastener 50 to a corresponding body 30. The connecting portion 66 of each mounting portion 64 of the connecting member 60 is received in the retaining slot 43 of a corresponding body 30 and between the restricting tab 45 and the projecting member 42. The orientating portion 68 of each mounting portion 64 of the connecting member 60 is depressed by the projecting member 42 and located under the extension tab 44. Each securing portion 70 of the connecting member 60 is engaged with the aperture 46 of a corresponding body 30. Thus, the connecting member 60 is mounted to a rear end of each body 30.

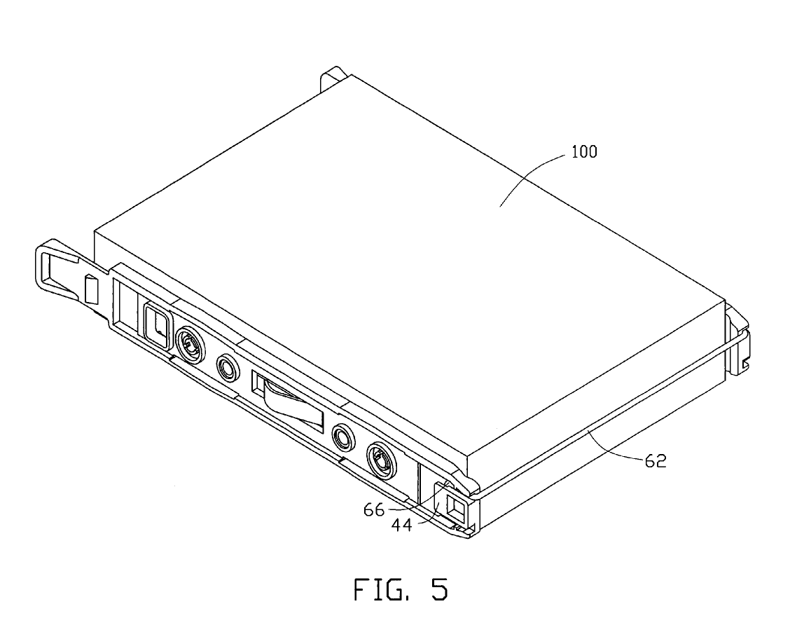

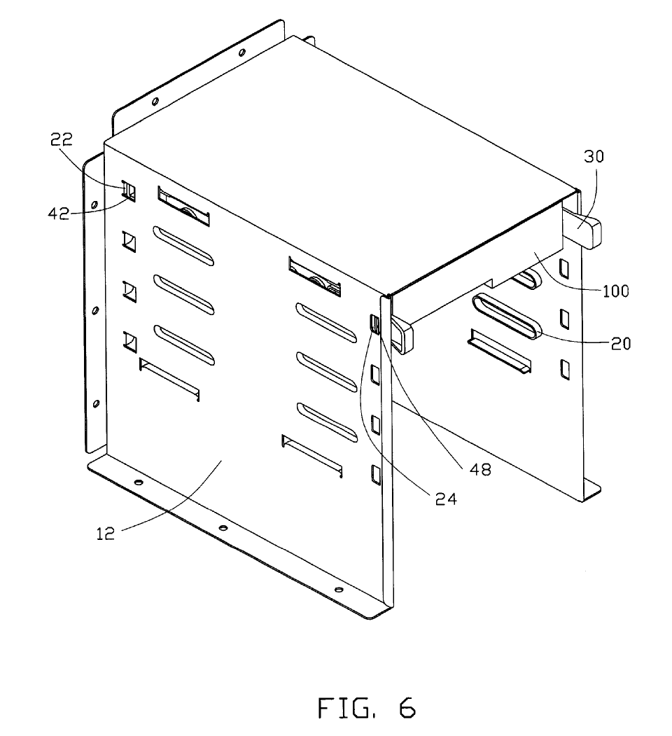

Referring also to FIGS. 4 to 6, in assembling the data storage device 100, the posts 56 of each rail 25 are engaged with the locking holes 104 of a corresponding sidewall 102 of the data storage device 100. The main part 62 is situated at a rear side of the data storage device 100. The combined assembly of the data storage device 100 and the rail assembly 25 is mounted to the bracket 10. Each body 30 of the rail assembly slides in a corresponding track between two corresponding rows of supporting members 20. Each blocking tab 22 blocks the rear end of the corresponding body 30. The protrusion 48 of each body 30 is engaged with the corresponding fixing hole 24 of the bracket 10. Thus, the data storage device 100 is secured.

In disassembling the data storage device 100, the operating portion 34 of each body 30 is pressed toward the data storage device 100. Two connecting portion 66 of the connecting member 60 are elastically warped during this step and rebound after removing the data storage device 100 from the bracket 10. The protrusion 48 of each body 30 is disengaged from the corresponding fixing hole 24 of the bracket 10. The combined assembly of the data storage device 100 and the rail assembly may be drawn from the bracket 10. Each tab 52 of the rails 25 is electrically contactable to a corresponding side wall 12 of the bracket 10 for grounding the data storage device 100 to the computer enclosure. During installation and un-installation of the data storage device 100, the rails 25 are not easily disengaged from the data storage device 100 because of the connecting member 60.

In an alternative embodiment, the connecting member 60 is mechanically connected between each body 30 and the data storage device 100 so that each rail 25 is able to be retained to the data storage device 100 because of the connecting member 60 and not easily disengaged therefrom.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. A rail assembly adapted for mounting a data storage device in a computer enclosure, comprising
a pair of rails each comprising a pair of posts extending therefrom to engage with the data storage device; and
a connecting member connecting the rails together.

2. The rail assembly as claimed in claim 1, wherein the connecting member is connected to rear ends of the rails.

3. The rail assembly as claimed in claim 2, wherein each of the rails comprises a body, and a conductive fastener mounted to the body, the posts protrude from the fastener.

4. The rail assembly as claimed in claim 3, wherein the connecting member comprises an elastic wire, the elastic wire comprises a main part having two distal ends, and a pair of mounting portions each extending from a corresponding distal end of the main part, each of the mounting portions is mounted to the rear end of a corresponding rail.

5. The rail assembly as claimed in claim 4, wherein a projecting member protrudes from the rear end of each body, a retaining slot is defined between the projecting member and an upper portion of each body, each of the mounting portions comprises a connecting portion perpendicularly extending forward from a corresponding distal end of the main part, and an orientating portion extending downwardly from a distal end of the connecting portion, the connecting portion is located in the receiving slot, the orientating portion is elastically depressed by a front end of the projecting member.

6. The rail assembly as claimed in claim 5, wherein a hole is defined in the rear end of the body below the retaining slot, each of the mounting portions of the elastic wire further comprises a securing portion perpendicularly extending from a distal end of the orientating portion toward the data storage device, the securing portions are engaged in the corresponding holes.

7. The rail assembly as claimed in claim 6, wherein an operating portion extends forward from the body of each of the rails, a protrusion protrudes from the operating portion for engaging with the computer enclosure.

8. The rail assembly as claimed in claim 7, wherein the body of each of the rails defines a through-hole therein, an arc-shaped elastic tab is stamped from the fastener of each of the rails for electrically connecting to the computer enclosure.

9. A mounting apparatus for mounting a data storage device that defines a pair of locking holes in each of two opposite sidewalls thereof, comprising
a pair of rails each adapted for attaching to a corresponding sidewall of the data storage device, each of the rails comprising a pair of posts extending therefrom for engaging with the corresponding locking holes of the data storage device;
a bracket for holding the data storage device comprising a pair of side walls each defining a track for holding a corresponding rail to slide therein; and
a connecting member connecting the rails to each other.

10. The mounting apparatus as claimed in claim 9, wherein the connecting member is connected to rear ends of the rails.

11. The mounting apparatus as claimed in claim 10, wherein each of the rails comprises a body, and a conductive fastener mounted to the body, the posts protrude from the fasteners.

12. The mounting apparatus as claimed in claim 11, wherein an avoiding slot is defined in the body of each of the rails opposite to the corresponding operating portion, for receiving a corresponding corner of the data storage device.

13. The mounting apparatus as claimed in claim 11, wherein the connecting member comprises an elastic wire, the elastic wire comprises a main part having two distal ends, and a pair of mounting portions each extending from a corresponding distal end of the main part, each of the mounting portions is mounted to the rear end of a corresponding rail.

14. The mounting apparatus as claimed in claim 13, wherein a projecting member protrudes from the rear end of each body, a retaining slot is defined between the projecting member and an upper portion of each body, each of the mounting portions comprises a connecting portion perpendicularly extending forward from a corresponding distal end of the main part, and an orientating portion extending downwardly from a distal end of the connecting portion, the connecting portion is located in the receiving slot, the orientating portion is elastically depressed by a front end of the projecting member.

15. The mounting apparatus as claimed in claim 14, wherein a hole is defined in the rear end of the body below the retaining slot, each of the mounting portions of the elastic wire further comprises a securing portion perpendicularly extending from a distal end of the orientating portion toward the data storage device, the securing portions is engaged in the corresponding aperture.

16. The mounting apparatus as claimed in claim 15, wherein an operating portion extends forward from the body of each of the rails, the operating portions each comprise a latch mechanism, each of the side walls of the bracket comprises a coupling mechanism at a front end thereof for engaging with the latch mechanisms.

17. The mounting apparatus as claimed in claim 16, wherein the body of each of the rails defines a through-hole therein, an arc-shaped elastic tab is stamped from the fastener of each of the rails for electrically connecting to a corresponding side wall of the bracket.

18. The mounting apparatus as claimed in claim 9, wherein a blocking tab extends from each of the side wall of the bracket at a rear end thereof.

19. An electronic device comprising:
an enclosure of said electronic device comprising a bracket defined therein, said bracket defining a space therein;
a functional component removably installable in said enclosure, said component movable to install in said space of said bracket and to be removed out of said space through a side of said bracket;
at least one rail removably attachable to said component and movable therewith, said at least one rail engagable with another side of said bracket other than said side thereof in order to retain said component in said space when said component moves into said space through said side of said bracket; and
a connecting member mechanically connectable with said at least one rail beside said component in order to retainably hold said at least one rail in an attached status to said component.

20. The electronic device as claimed in claim 19, wherein said at least one rail comprises a pair of rails attachable to two opposite sides of said component respectively, and said connecting member is mechanically connectable between said pair of rails in order to retain each rail of said pair of rails close to said component.
